(19) United States
(12) Patent Application Publication
(10) Pub. No.: US 2016/0285408 A1
(43) Pub. Date: Sep. 29, 2016

(54) CLAMP FOR SECURING AND ELECTRICALLY BONDING SOLAR PANELS TO A RAIL SUPPORT

(71) Applicant: Ironridge, Inc., Hayward, CA (US)

(72) Inventors: Jon Ash, Phoenix, AZ (US); Shawn J. Meine, Phoenix, AZ (US)

(73) Assignee: IronRidge, Inc., Hayward, CA (US)

(21) Appl. No.: 15/081,282

(22) Filed: Mar. 25, 2016

Related U.S. Application Data
(60) Provisional application No. 62/137,909, filed on Mar. 25, 2015.

(51) Int. Cl. H02S 20/23; H02S 40/34; H01B 5/02

(52) U.S. Cl. CPC H02S 20/23; H01B 5/02; H02S 40/34

(57) ABSTRACT

In various representative aspects, a clamp assembly that secures a solar panel module to a rail support structure that utilizes a generally L-shaped clamp in combination with a t-bolt such that the t-bolt fits through an aperture in the L-shaped clamp. This enables the foot of the t-bolt to be inserted into a guide on the top of the rail support structure so that the clamp can subsequently secure the solar panel module to the rail support structure by using a nut to rotate and tighten the t-bolt within the guide and the top of the clamp is then tightened with continuous rotation of the binding bolt, which also enables raised portions on the foot of the t-bolt and top of the clamp to penetrate surface layers of the rail support and the solar panel module respectively to create an electrical bonding path between the solar panel module and the rail support structure.

### BACKGROUND OF INVENTION

1. Field of the Invention

The present invention relates generally to providing an apparatus for securing a solar panel module to a rail support structure. More specifically, the invention relates to the use of a t-bolt with a generally L-shaped end clamp that mounts the end clamp to the top of a solar panel module on one end and the t-bolt in a guide of the rail support structure on another end, while also mechanically fastening and electrically bonding the solar panel module to the rail support structure.

2. Description of the Related Art

Any discussion of the prior art in the specification should in no way be considered as an admission that the prior art is widely known or forms part of common general knowledge in the field.

The installation of solar panel arrays on residential roofs can be arduous and time-consuming. Depending on the array design, the components required to install the array can make the installation process even more difficult. Many of the assembly components are difficult to install because they require special tools or are positioned in difficult places to reach on their support elements.

Solar panel arrays can be installed using different rail support structures. One type of rail support structure utilizes a series of rails that are arranged in rows across a roof and fixed to flashings that are secured to the roof. The solar panels are then arranged in an array and secured to the top of these rails.

There are various techniques to secure the solar panels to the rails. One type of rail support structure includes slots or guides along the top of the rail for receiving mounting hardware used to secure the solar panels to the rails. One type of mounting hardware is an end clamp that mounts to the outer perimeter of the solar panel module by using a t-bolt to secure the end clamp to the rail structure. The solar panel module is secured on one end by the top of the end clamp and on the other end by securing the head of a t-bolt within the rail guide.

A limitation of these types of end clamps that use t-bolts as the means to secure the end clamp to the solar panel module is that the t-bolt is often difficult to tighten using standard nut and t-bolt combinations. This is so because the head of the t-bolt, once inserted into the guide at the top of the rail does not remain fixed within the guide making the use of a standard nut to tighten the clamp often clumsy and difficult. It is desirable to provide an end clamp that not only secures the solar panels to the rails outer perimeter of the array, but is also easy to install. The terms “clamp” and “end clamp” are used interchangeably as it applies to the present invention.

Another desirable feature is to be able to provide an electrical bonding path between the solar panel modules and the rail guides without having to use unsightly wiring to connect all of the components. One way this can be accomplished is by using the end clamp and the t-bolt to provide the conducting path by creating an electrical connection to the solar panel modules and rail guides respectively.

Existing clamps are either unsatisfying in providing a way to secure solar panel modules to rails with guides or slots located on the top of the rails and in providing an electrical bonding path between the solar panel modules and the rail support structures. For example, European Patent No. 2636970 and U.S. Patent Application 2009/0232616 teach an L-shaped end clamp apparatus that is used to secure a solar panel module to a rail support structure. The end clamp includes an aperture on its bottom for receiving a t-bolt. The head of the t-bolt is inserted into a guide of the rail support structure and the elongated threaded portion of the t-bolt is inserted through the aperture of the clamp. The clamp is then tightened to the rail support structure by using a standard nut on the top of the threaded portion of the t-bolt. The top of the end clamp has a lip that rests on the top of the solar panel and is secured when the clamp is tightened. But the clamps disclosed in each of these references do not include a means for providing an electrical bonding path between the solar panel module and the rail support guide through the clamp. The present invention overcomes this limitation by using a t-bolt with an enlarged end that has raised portions on its perimeter that engage and penetrate the inner surface of the guide, and including raised portions on the top lip of the end clamp that penetrate the outer surface layer of the solar panel module to complete the electrical bonding path from the solar panel module to the rail support. As the t-bolt is rotated and the raised portions on the enlarged end penetrate surface layer of the guide, the enlarged end is lodged into the guide thereby keeping it fixed to the rail and making the securing of the clamp much easier.

The present invention overcomes the limitations in the prior art and provides a solution that is both easy to install and use.

### SUMMARY OF THE INVENTION

The invention is summarized below only for purposes of introducing embodiments of the invention. The ultimate scope of the invention is to be limited only to the claims that follow the specification.

It is an object of this invention to provide a clamp for securing a solar panel module to a supporting rail structure.

It is a further object of this invention that the clamp is a generally L-shaped body.

It is a further object of this invention that one end of the clamp includes an aperture that can receive an elongated bolt through it.

It is a further object of this invention that the top side of the clamp includes a lip that has at least one raised portion for electrically bonding to the top surface of the solar panel module by having the raised portion penetrate a surface layer of the solar panel module.

It is a further object of this invention that the elongated bolt is a t-bolt.

It is a further object of this invention that the t-bolt includes an enlarged end on one end of a threaded bolt portion.

It is a further object of this invention that the enlarged end of the t-bolt include at least one raised portion capable of penetrating a surface layer of the rail guide.

It is a further object of this invention that the t-bolt be tightened by using a nut.

It is a further object of this invention that the nut is serrated on one side.

It is a further object of this invention to provide a method of assembling a solar panel to a rail support structure utilizing the components described below.

A person with ordinary skill in the relevant art would know that any shape or size of the elements described below may be adopted as long as the end clamp can be used to secure solar panel modules to the rail support structures and a nut is used to tighten the t-bolt to the guide of the rail support structure. Any combinations of suitable number, shape, and size of the elements described below may be used. Also, any materials suitable to achieve the object of the current invention may be chosen as well.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1 illustrates a perspective view of an exemplary clamp assembly.

FIG. 2 illustrates a rear view of the clamp assembly.

FIG. 3 illustrates a front view of the clamp assembly.

FIG. 4 illustrates a side view of the clamp assembly.

FIG. 5 illustrates a top view of the clamp assembly.

FIG. 6 illustrates a bottom view of the clamp assembly.

FIG. 7 illustrates a front perspective view of the clamp assembly.

FIG. 8 illustrates a rear view of the clamp assembly assembled to a solar panel and rail support structure.

FIG. 9 illustrates a cross-sectional view (9-9) from FIG. 8 of the top lip of the clamp showing its raised portion penetrating the surface layer of the top of the solar panel module.

FIG. 10 illustrates a cross sectional view (10-10) from FIG. 8 of raised portions of a t-bolt and serrations on a nut penetrating the surface layer of the rail and bottom portions of the clamp respectively.

FIG. 11 shows an exploded view of the clamp assembly.

FIG. 12 is a rear perspective view of the installed clamp assembly.

### DETAILED DESCRIPTION OF THE INVENTION

In the following description, and for the purposes of explanation, numerous specific details are provided to thoroughly understand the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed embodiments may be applied. The full scope of the invention is not limited to the example(s) that are described below.

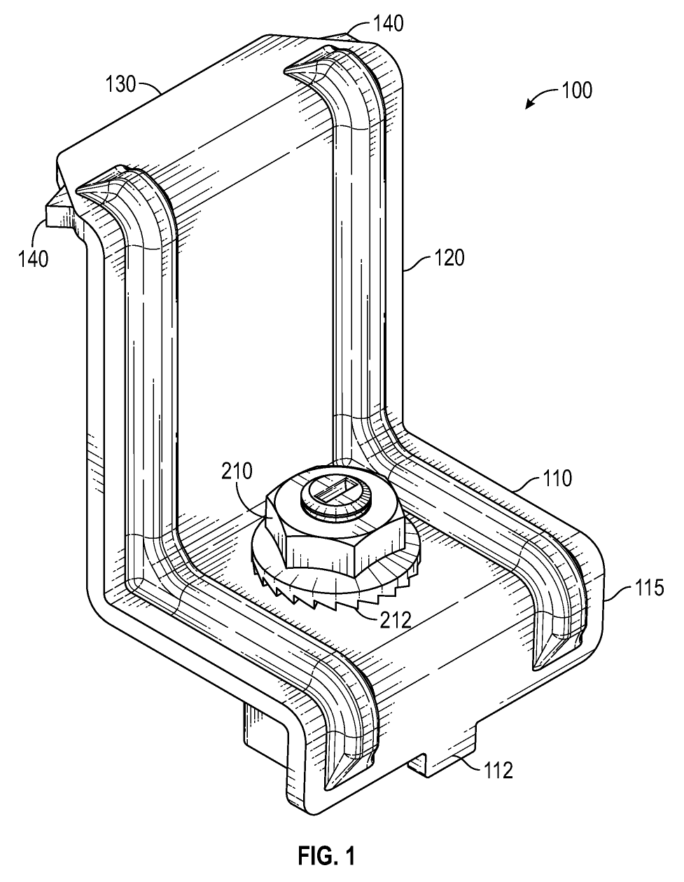

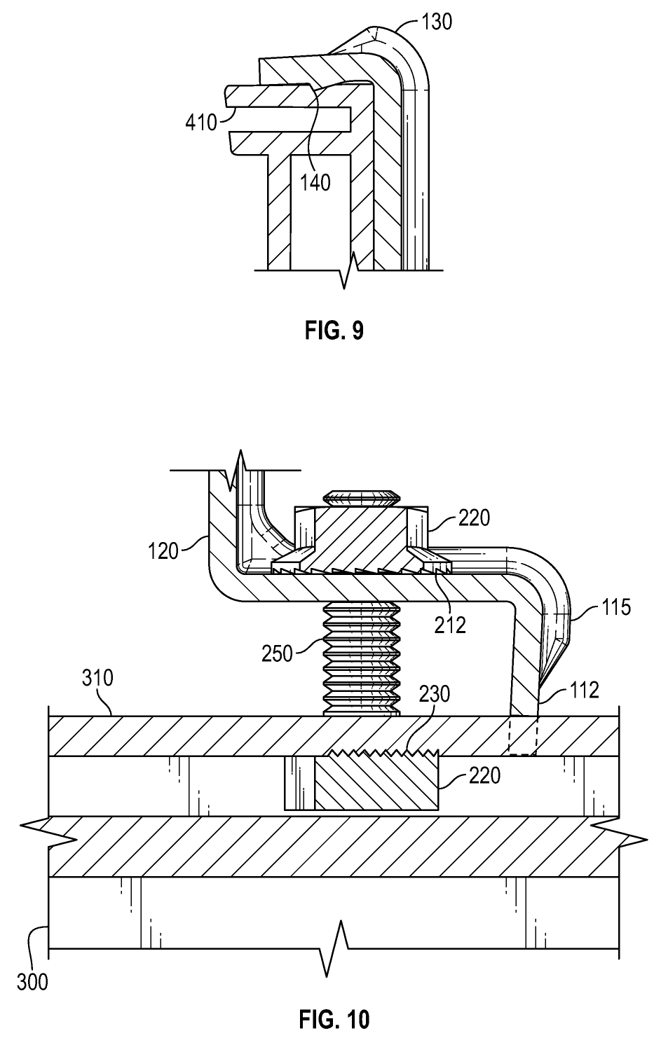

FIG. 1 shows a rear perspective view of a clamp 100 for use in fastening a solar panel module to a rail support structure 300 (as shown in FIGS. 9 and 10). The exemplary embodiment of the clamp 100 is generally a L-shaped or S-shaped structure that includes a top lip 130, a middle portion 120, and a lower portion 110. The middle portion 120 is of suitable length and is typically long enough to enable the top lip 130 to reach over the top of the solar panel 400 when the clamp 100 is secured to the guide 300. An optional bottom lip 115 extends from the lower portion 110 is also shown and includes a flange 112 that typically fits within the guide 310 and can provide additional stability to the clamp 100 when it is secured to the guide 300.

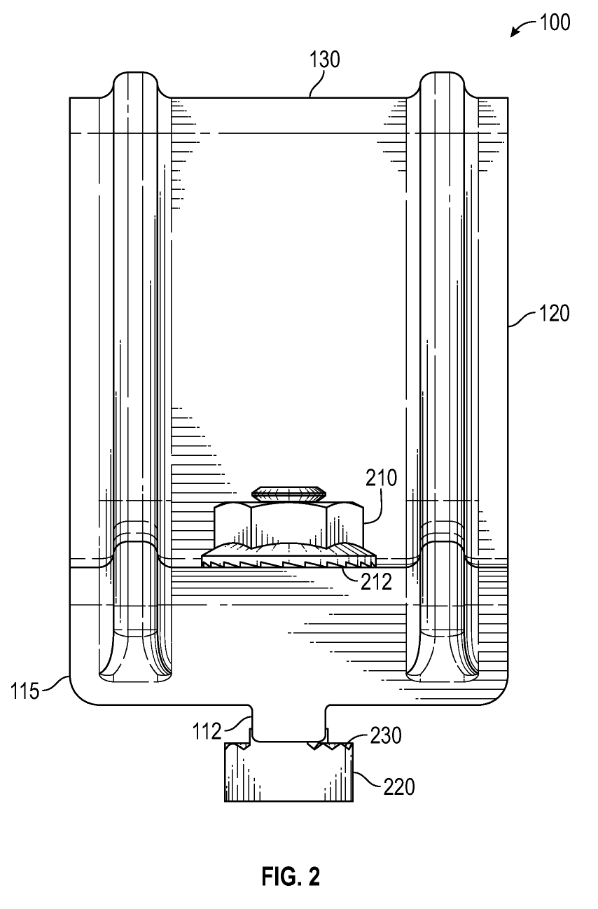

The top lip 130 extends outward and engages the top section 410 of the solar panel module 400 (also shown in FIGS. 9 and 10). A pair of raised portions 140 extend downward from the top lip 130. The raised portions 140 are utilized for penetrating the outer surface layer of the top section 410 of the solar panel module 400. The raised portions 140 are blunt enough to penetrate the outer surface layer when the top lip 130 is driven downward onto the solar panel module 400. The use of a single raised portion 140 is sufficient, but utilizing a plurality of raised portions 140 improves the connection between the solar panel module 400 and the clamp 100. The clamp 100 is typically made from an electrically conducting material. A nut 210 is shown connected to an elongated portion 250 of a t-bolt 200 in FIG. 1 and the rear view of the clamp FIG. 2. The nut 210 shown is a flange nut and may include a serrated bottom 212, but any suitable nut capable of tightening the t-bolt 200 will suffice. The lower portion 110 also includes an aperture 125. The aperture 125 receives the elongated portion 250 of the t-bolt 200. The t-bolt 200 includes an enlarged end 220 that is typically coupled to an end of the elongated portion 250. The enlarged end 220 also includes raised portions 230. The raised portions 230 are typically blunt enough to penetrate a surface layer of the inner portion of the rail guide 310 (as shown in FIGS. 9 and 10). The use of a single raised portion 140 would be sufficient, but utilizing a plurality of raised portions 140 improves the connection between the solar panel module rail guide 310 and the clamp 100.

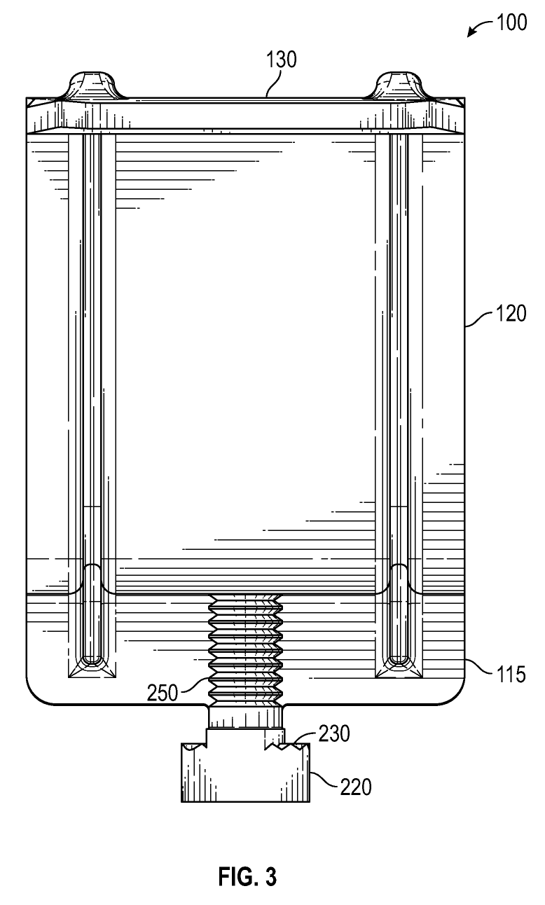

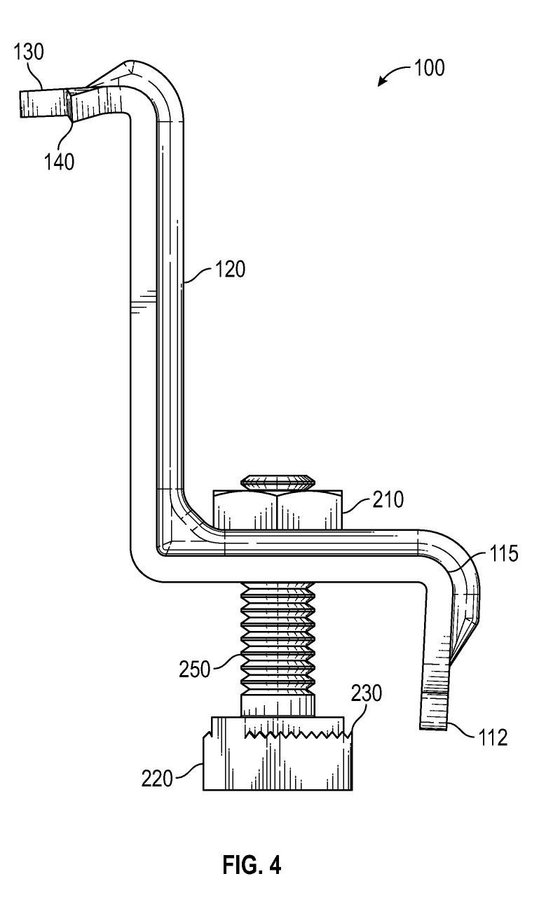

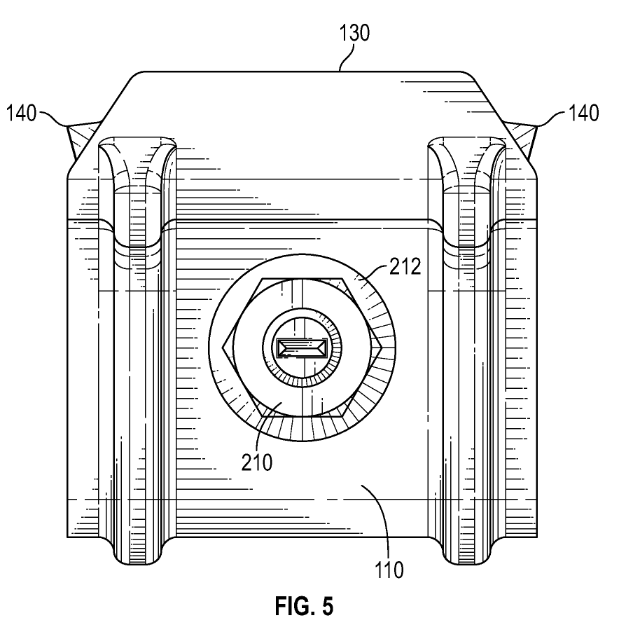

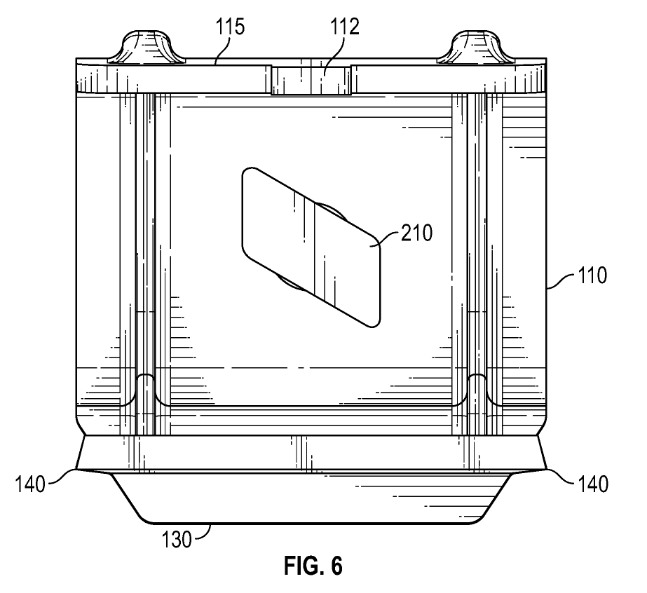

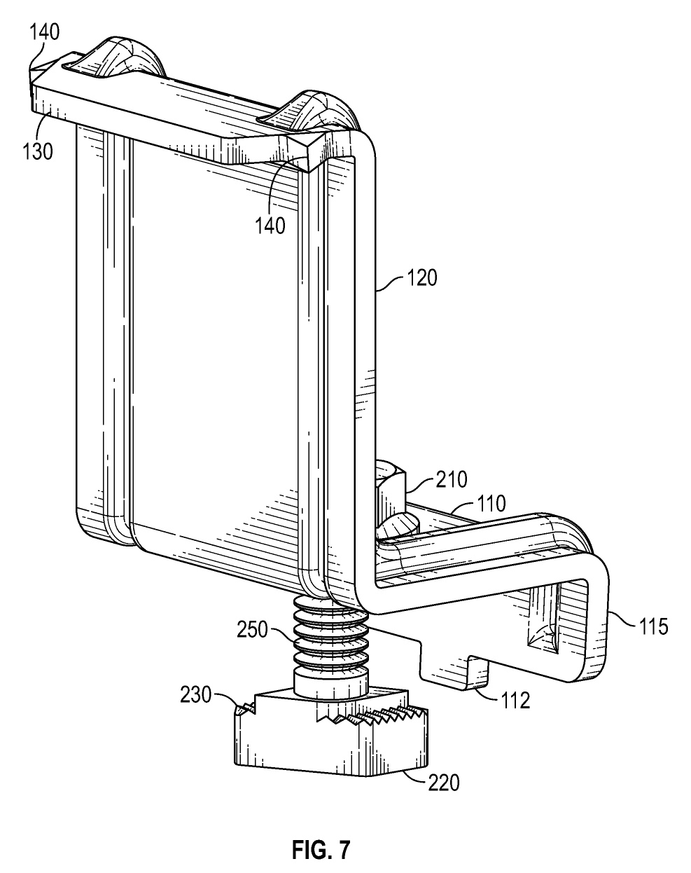

FIG. 3 shows a front view of the clamp 100. The raised portions 140 on the top lip 130 are shown in more detail protruding downward from the top lip 130. The elongated portion 250 of the t-bolt 200 is also shown and is typically threaded. FIGS. 4-7 show additional views of the clamp 100 with the features as described above.

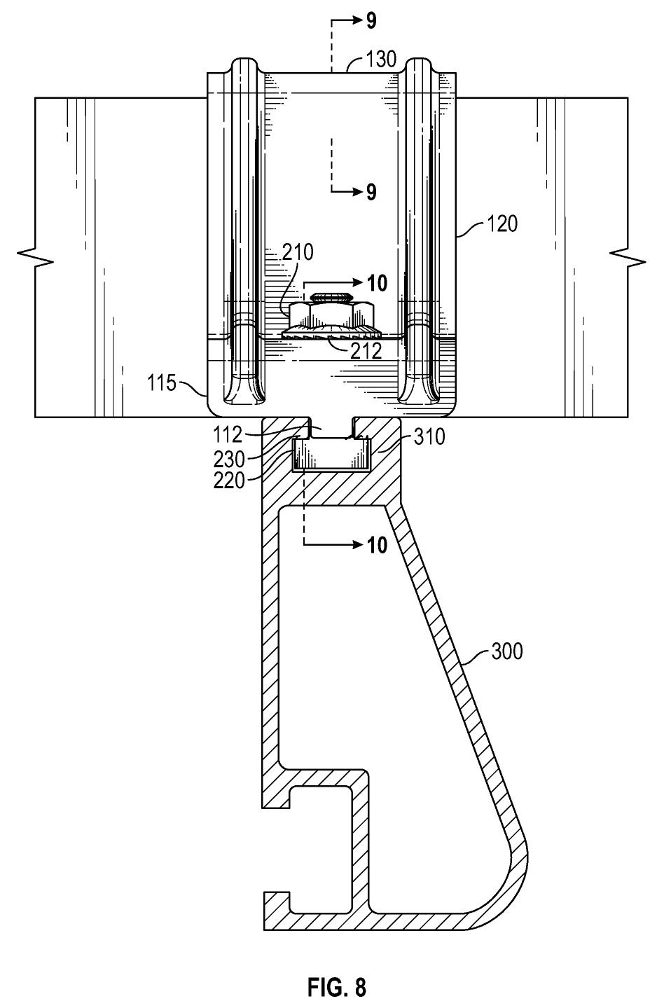

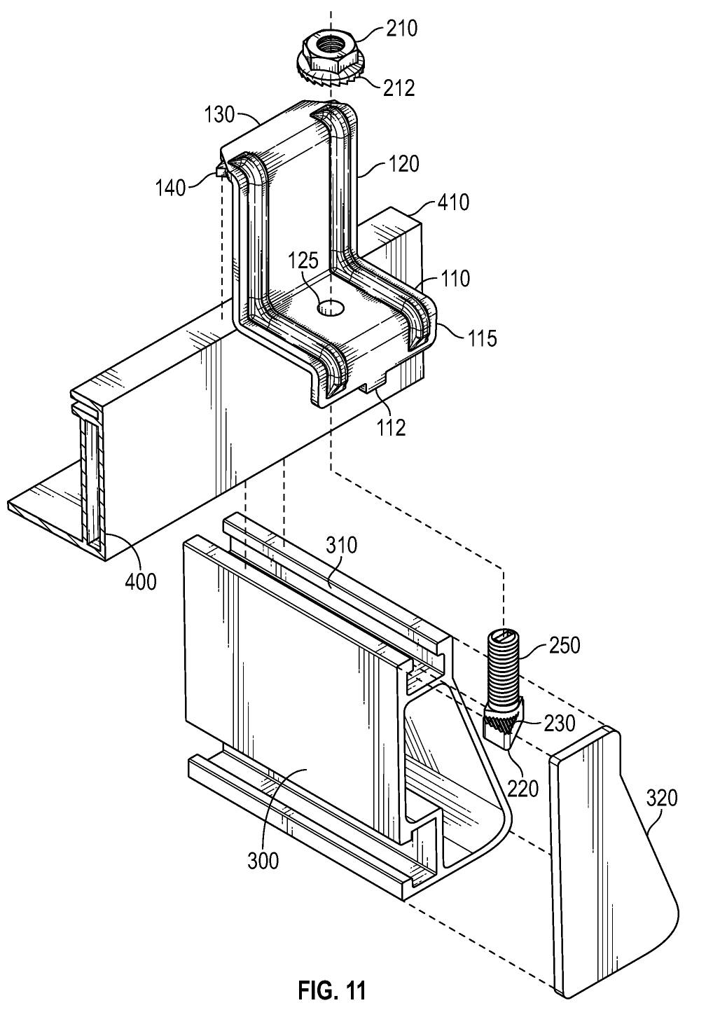

FIG. 8 shows a rear view of the clamp 100 as it is typically installed. As also shown in FIG. 11, the solar panel 400 is placed on top of the guide 310 of the rail support 300. The guide 310 is a slot and normally extends along the length of the guide rail support 300. The enlarged end 220 of the t-bolt 200 is then inserted into the guide 310. The clamp 100 is then placed over the elongated portion 250 of the t-bolt 200 so that the elongated portion 250 passes through the aperture 125 of the clamp 100. The clamp 100 is then manually moved forward until the clamp 100 engages the solar panel 400. The rail support 300 can be covered at one end with a cover 320.

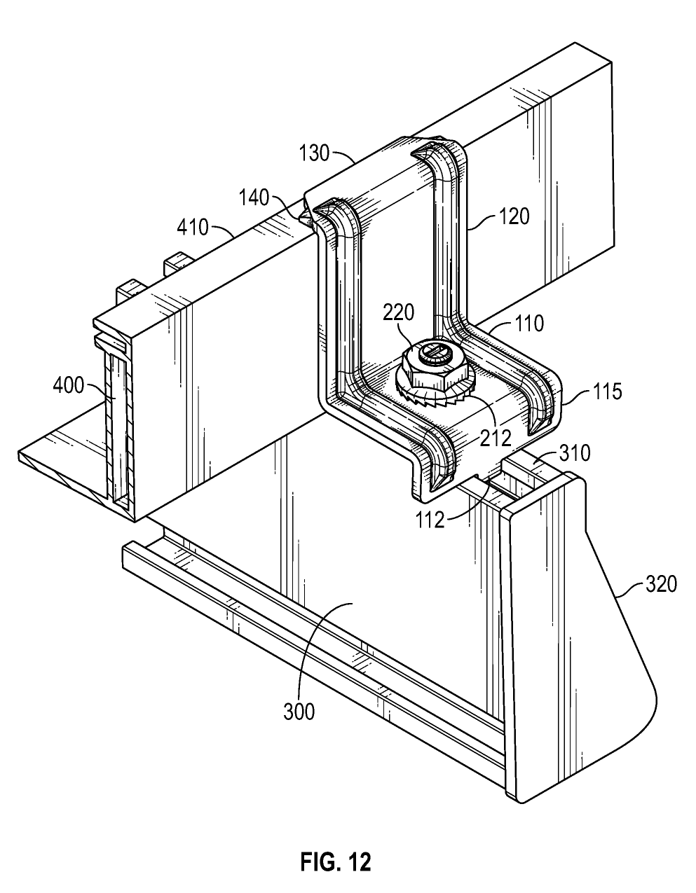

The top lip 130 is then placed on the top portion 410 of the solar panel module 400. The nut 210 is then set on the threads of the elongated portion 250 and is rotated clockwise. As shown in the cross-sectional view FIG. 10 of the guide 310, once rotated, the enlarged end 220 of the t-bolt 200 is also rotated so that the enlarged end 220 frictionally engages the inner portion of the guide 310 and enables the nut 210 to continue turning and tightening the lower portion 110 to the rail support 300. As the nut 210 continues to rotate, the serrations 212 on the flange begin to penetrate the surface of the lower portion 110 of the clamp 100 thereby creating an electrical contact, and as shown in FIG. 10, the raised portions 230 penetrate the surface layer of the inner portion of the guide 310. As shown in FIG. 9, the tightening process also creates a downward force on the top lip 130 that secures it to the top portion 410 of the solar panel module 400 and causes the raised portion 140 on the top lip 130 to penetrate the outer surface layer of the top portion 410 thereby creating an electrical bonding path between the solar panel module 400 and the rail support 300 through the clamp 100. FIG. 12 shows a perspective view of the completed assembly with all of the features described above.

This process is repeated until all the solar panel modules are installed in the array.

What is claimed is:

1. A clamp assembly for securing a solar panel module to a rail support and providing an electrical bonding path between them comprising:
a. a middle portion;
b. a top lip coupled to a first end of the middle portion wherein the top lip further comprises a raised portion;
c. a lower portion coupled to a second end of the middle portion wherein the lower portion further comprises an aperture;
d. a t-bolt further comprising:
i. an elongated bolt; and
ii. an enlarged end wherein the enlarged end is coupled to a first end of the elongated bolt; and
e. a nut capable of coupling to a second end of the elongated bolt.

2. The clamp assembly of claim 1 wherein the top lip, middle portion, and lower portion comprise a generally L-shaped structure.

3. The clamp assembly of claim 1 further comprising a flange extending from the lower portion and has a width that is less than the width of the lower portion.

4. The clamp assembly of claim 1 wherein the elongated bolt of the t-bolt is threaded.

5. The clamp assembly of claim 1 wherein the enlarged end of the t-bolt further comprises at least one raised portion.

6. The clamp assembly of claim 1 wherein the nut further comprises a serrated side.

7. The clamp assembly of claim 1 wherein the nut further comprises a serrated flange.

8. The clamp assembly of claim 1 wherein the raised portion of the top lip extends outward from the top lip.

9. The clamp assembly of claim 1 wherein the enlarged end is perpendicular to the first end of the elongated bolt.

10. The clamp of claim 1 wherein the clamp assembly is made from an electrically conducting material.

11. A method of securing a solar panel module to a rail support comprising the steps of:
a. placing a solar panel module on a rail support further comprising a guide along an end of the rail support;
b. inserting an enlarged end of a t-bolt into the guide wherein the t-bolt further comprises an elongated portion coupled to the enlarged end and the enlarged end further comprises a raised portion;
c. inserting the elongated portion of the t-bolt through an aperture of a lower portion of a clamp wherein the clamp further comprises:
i. a top lip coupled to a first end of the middle portion wherein the top lip further comprises a raised portion; and
ii. a lower portion coupled to a second end of the middle portion;
d. coupling the top lip to a top portion of the solar panel module;
e. turning a nut further comprising a serration on a bottom side of the nut clockwise around the elongated portion until the turning of the nut:
i. creates a rotational force applied to the enlarged end causing the raised portion of the enlarged end to penetrate a surface layer of the inner portion of the guide;
ii. creates a downward force applied to the top lip that causes the raised portion on the top lip to penetrate an outer surface layer of the solar panel module; and
iii. causes the serration to penetrate the surface of the lower portion thereby creating an electrical bonding path between the solar panel module and the rail support through the clamp.

12. The method of claim 11 wherein the top lip, middle portion, and lower portion comprise a generally L-shaped structure.

13. The method of claim 11 wherein the lower portion further comprises a flange extending from the lower portion and has a width that is less than the width of the lower portion.

14. The method of claim 11 wherein the elongated bolt of the t-bolt is threaded.

15. The method of claim 11 wherein the clamp assembly is made from an electrically conducting material.

16. The method of claim 11 wherein the nut further comprises a serrated flange and further comprises the step of turning the nut until the serrations penetrate the lower portion of the clamp.
